(19) United States
(12) Patent Application Publication
(10) Pub. No.: US 2009/0023567 A1
(43) Pub. Date: Jan. 22, 2009

(54) Coated Member, Especially Roller, Made of Carbon Fiber-Reinforced Plastic (CFK) for Paper Machines and Printing Presses, and Method for the Production of such a Member

(76) Inventors: Gerhard Johner, Gelnhausen (DE); Markus Kirst, Buttelborn (DE)

Correspondence Address: PRAXAIR, INC.;LAW DEPARTMENT - M1 557, 39 OLD RIDGEBURY ROAD, DANBURY, CT, 06810-5113, US

(21) Appl. No.: 11/884,912

(22) PCT Filed: Feb. 16, 2006
(86) PCT No.: PCT/DE2006/000287

§ 371 Date: Jul. 25, 2008

(30) Foreign Application Priority Data
Feb. 24, 2005 (DE) 10 2005 008 487.7

(51) Int. Cl. F16C 13/00; B05D 1/08; D21G 1/02; D21F 1/40; B05D 1/36

(52) U.S. Cl. 492/52; 427/454; 492/28; 492/54

(57) ABSTRACT

Coated body of carbon fiber reinforced plastic (CFP) for paper machines and printing machines, particularly roller, comprising an adhesion promoter layer and a wear protective layer of hard metal or oxide ceramics which is applied onto the adhesion promoter layer, characterized in that the adhesion promoter layer consists of ductile metal selected from the group consisting of copper, nickel, iron, lead and tin and is applied by plasma spraying or flame spraying.

The invention relates to a coated body, particularly roller, of carbon fiber reinforced plastic (CFP) for paper machines and printing machines, comprising an adhesion promoter layer and a wear protective layer of hard metal or oxide ceramics which is applied onto the adhesion promoter layer, as well as to a method for producing such a body.

CFP roller bodies enjoy increasing popularity in paper machines and printing machines in view of both their low weight and extreme flexural strength. There is only the disadvantage that a coating, usually for protection against wear or other stress, is required, which coating, at the present state of the art, substantially increases the price. Coatings in the form of ceramic and hard metal coatings have been generally accepted, wherein these coatings mainly are produced by thermal spraying, particularly plasma- and flame spraying. Complicated and therefore costly are not so much these known coating methods, but rather is the so far usual preparation of the adherend surface, which preparation is described for example in DE 41 16 641 A1 and in EP 0 514 640 B1, respectively. In this preparation process the CFP roller is coated with a further layer of synthetic resin into which large volumes of a typical adhesion promoter consisting of NiAl or NiCr powder beforehand have been dispersed. Curing of this outer layer of synthetic resin is followed by a first grinding step, whereby the dispersed adhesion promoter particles are ground. These ground adhesion promoter particles so to speak define the adherend spots for the further treatment by thermal spraying with NiCr or NiAl adhesion promoter and the subsequent application of the functional layer consisting of ceramic material or hard metal. Such coatings merely are possible if the thermal load of the CFP roller body is kept sufficiently low by adequate cooling measures, so as to definitely avoid a delamination of the carbon fibers within the matrix of synthetic resin as well as any damaging of the latter. Attempts to avoid this costly preparation of the adherend surface according to EP 0 514 640 B1, e.g. by wire spraying of zinc, frequently failed because of the insufficient ductility of zinc which lead to the formation of fissures in the desired adhesion promoter layer, what finally resulted in spalling of the layer from CFP body to be coated.

Besides it is known (DE 34 27 554 A1) to galvanically copperplate CFP bodies, to activate the copper layer by immersing it into an acid electrolyte, to provide for an intermediate rinsing in de-ionized water, to electroplate an adhesion promoting metal layer of nickel, cobalt, iron or tin in an acid electrolyte on the activated copper layer such that branching tree-type structural elements are produced on the surface, to provide for further intermediate rinsing in de-ionized water, to stabilize the surface carrying the structural elements by immersion into an electrolyte, to again rinse in de-ionized water, and then to air-dry the metal layer. Such a procedure is complicated and therefore likewise results in a price increase.

A gravure printing roller including a sleeve of thermally wound, fiber reinforced thermoplastics is known from DE 93 05 806 U1, wherein the fiber reinforcement may consist, among others, of carbon fibers. A layer of copper or of a copper alloy is directly applied by thermal spraying, particularly plasma spraying or high velocity flame spraying, onto the previously roughened outer surface of a base body of thermoplastic, fiber reinforced plastic material. The gravure required for the gravure printing process is made in the copper layer.

DE 100 37 212 A1 describes a fiber reinforced and at least partly thermally coated plastic material particularly for use in sporting goods, for example at the head of a golf club. An adhesion base layer of zinc, zinc alloys, aluminum alloys and/or of materials which are exothermally acting in the course of the spraying process, such as nickel-aluminum or molybdenum, is applied on a plastic base body which e.g. is carbon fiber reinforced. A wear protective layer of metals, metal alloys, oxides, carbides, borides, plastic materials or mixtures of the aforementioned materials is applied onto the adhesion base layer.

Furthermore EP 0 850 899 A1 discloses a method for coating carbon substrates or non-metallic, carbon-containing substrates in which a base layer of rhenium, molybdenum, zirconium, titanium, chromium, niobium, tantalum, hafnium, vanadium, platinum, rhodium or iridium is applied by plasma spraying onto a substrate surface heated to a temperature from 500° C. to 2500° C., and in which subsequently a cover layer is applied which at least partly consists of high-melting metal.

JP 02 270 954 A describes a method in which a CFP cylinder for paper machines is preheated and is provided by plasma spraying with a molybdenum base layer, and in which a ceramic protective layer is applied by flame spraying onto the thus produced molybdenum base layer.

A method for multi-layer coating of plastic materials with metals or alloys by flame spraying, wherein the first one of the applied layers has a coefficient of thermal expansion greater than that of the plastic material, whereas the succeeding layer or layers has (have) a coefficient or coefficients of thermal expansion lower than that of the plastic material, is known from GB 887 366.

The problem basic to the invention is to provide for a coated body, particularly a roller, of carbon fiber reinforced plastic (CFP) for paper machines and printing machines, and for a method for producing such a body, which do not require a complicated pre-treatment of the surface of CFP bodies, particularly rollers of CFP, of the type described in EP 0514640 B1 or in DE 3427554 C2, which nevertheless provide for an adhesion promotion leading to a long-time secure seat on the body, and which are suited for further coatings consisting of wear resistant oxide ceramics or hard metal.

The problem basic to the invention is solved by the coated body of claim 1 and the method of claim 7. Particularly, the adhesion promoter layer of a coated body of the type indicated at the beginning consists of ductile metal selected from the group consisting of copper, nickel, iron, lead and tin, and the adhesion promoter layer is applied by plasma spraying or flame spraying.

It was found that such an adhesion promoter layer can be produced in a relatively simple and fast manner and forms an outstanding adherend surface for protective layers applied thereon.

Advantageous further developments of the invention are set out in the subclaims.

Thus, the adhesion promoter layer of ductile metal advantageously is applied at a thickness from 0.01 mm to 3.0 mm, and preferably of about 0.1 mm.

It turned out to be particularly advantageous to maintain, during application of the adhesion promoter layer, the CFP body, particularly a roller body, at a circumferential speed of at least 0.3 m/sec and, by suitable cooling measures, at a temperature not exceeding 200° C. Thereby a closed, crack-free metal ring is swiftly formed around the CFP roller body, and the cooling-induced volume shrinking of this metal ring results in a tightly adhering frictional connection with the CFP roller body.

Thereupon, wear protective layers of oxide ceramics, such as chromium oxide (Cr₂O₃), aluminium oxide (Al₂O₃), titanium dioxide (TiO₂), quartziferous mullite (for example 3Al₂O₃.2SiO₂ to 2Al₂O₃.SiO₂), zirconium oxide (ZrO₂) and mixtures thereof, as well as of wear-resistant hard metals, such as those selected from the group of tungsten carbide/cobalt (WC/Co), tungsten carbide/nickel (WC/Ni), titanium carbide/nickel (TiC/Ni), nickel-chromium/chromium carbide (Cr₃C₂/NiCr), nickel-chromium-boron-silicon (NiCrBSi), fused carbide (pure chromium carbide), chromium, molybdenum together with oxygen, etc. are applied in a further step, preferably by thermal spray processes, such as plasma spraying, flame spraying and high velocity flame spraying.

Furthermore, these outer coatings also may be provided, in a manner known per se (EP 0 999 043 A1), with a non-stick sealing.

The wear protective layer of oxide ceramics or hard metal need not be applied by thermal spraying; rather, it may likewise be applied by other coating processes, such PVD (physical vapour deposition), CVD (chemical vapour deposition), sintering, hot isostatic pressing, electroplating, explosive plating, surface welding, soldering, brazing, adhesive bonding techniques or reactive processes under conditions at which delaminating of the carbon fibers within the plastic matrix and damaging of the latter is avoided.

In the preferred embodiments the wear protective layer has a thickness from 0.01 mm to 3.0 mm, and preferably of 0.1 mm.

Dependent on the respective application, surface qualities are required, which, subsequent to the coating process, make a grinding and polishing operation necessary, so that a proper surface roughness of the wear protective layer may be adjusted; this surface roughness preferably is between 1.0 μm<Rz<90 μm, and particularly is Rz=15 μm to 20 μm.

1. Coated body of carbon fiber reinforced plastic (CFP) for paper machines and printing machines, particularly roller, comprising an adhesion promoter layer and a wear protective layer of hard metal or oxide ceramics which is applied onto the adhesion promoter layer, characterized in that the adhesion promoter layer consists of ductile metal selected from the group consisting of copper, nickel, iron, lead and tin and is applied by plasma spraying or flame spraying.

2. Coated body according to claim 1, characterized in that the adhesion promoter layer of ductile metal has a thickness from 0.01 mm to 3.0 mm, and preferably of about 0.1 mm.

3. Coated body according to claim 1 characterized in that the wear protective layer of hard metal or oxide ceramics has a thickness from 0.01 mm to 3.0 mm, and preferably of 0.2 mm.

4. Coated body according to claim 1, characterized in that the wear protective layer of hard metal or oxide ceramics has a surface roughness of between 1.0 μm<Rz<90 μm, and particularly of Rz=15 μm to 20 μm.

5. Coated Body according to claim 1, characterized in that the hard metal layer consists of WC/Co, WC/Ni, TiC/Ni, Cr₃C₂/Ni, NiCrBSi or molybdenum or of mixtures of said hard metals.

6. Coated body according to claim 1, characterized in that the oxide ceramics layer consists of Al₂O₂, Cr₂O₃, TiO₂, SiO₂, or ZrO₂ or of mixtures thereof.

7. Method for producing a coated body of carbon fiber reinforced plastic (CFP) for paper machines and printing machines, particularly roller, wherein an adhesion promoter layer of ductile metal selected from the group consisting of copper, nickel, iron, lead and tin is applied by plasma spraying or flame spraying onto a CFP body, whilst the body if maintained by cooling measures at a temperature not exceeding 200° C., and wherein in a further step a wear protective layer of hard metal or oxide ceramics is applied onto the adhesion promoter layer.

8. Method according to claim 7, wherein, during the coating step, the CFP roller body is maintained at a circumferential speed of at least 0.3 m/sec.

9. Method according to claim 7, wherein the adhesion promoter layer is applied at a thickness from 0.01 mm to 3.0 mm, and preferably of about 9.1 mm.

10. Method according to claim 7, wherein the wear protective layer of hard metal or oxide ceramics is applied at a thickness from 0.01 mm to 3.0 mm, and preferably of 0.2 mm.

11. Method according to claim 7, wherein the surface roughness of the wear protective layer of hard metal or oxide ceramics is adjusted by grinding and polishing to a value of between 1.0 μm<Rz<90 μm, and particularly of Rz=15 μm to 209 μm.

12. Method according to claim 7, including the further step of applying onto the adhesion promoter layer a hard metal layer of WC/Co, WC/Ni, TiC/Ni, Cr₃C₂/Ni, NiCrBSi or molybdenum or of mixtures of said hard metals.

13. Method according to claim 7, wherein the hard metal layer is applied by thermal spraying such as plasma spraying, flame spraying and high velocity flame spraying.

14. Method according to claim 7, wherein an oxide ceramics layer of Al₂O₂, Cr₂O₃, TiO₂, SiO₂, or ZrO₂ or of mixtures thereof is applied in said further method step onto the adhesion promoter layer.

15. Method according to claim 7, wherein the oxide ceramics layer is applied by thermal spraying such as plasma spraying and flame spraying.

16. Method according to claim 7, wherein the wear protective layer of hard metal or oxide ceramics is applied in a further method step by coating processes, such as PVD (physical vapour deposition), CVD (chemical vapour deposition), sintering, hot isostatic pressing, electroplating, explosive plating, surface welding, soldering, brazing, adhesive bonding techniques or reactive processes, under conditions at which a delamination of the carbon fibers wherein the plastic matrix and a damaging of the latter is avoided.
